(19) United States
(12) Patent Application Publication
(10) Pub. No.: US 2006/0201283 A1
(43) Pub. Date: Sep. 14, 2006

(54) Open Wrench

(76) Inventor: Tony Petkovic, Vancouver (CA)

Correspondence Address: GREENBLUM & BERNSTEIN, P.L.C., 1950 ROLAND CLARKE PLACE, RESTON, VA, 20191, US

(21) Appl. No.: 10/906,924

(22) Filed: Mar. 12, 2005

(51) Int. Cl. B25B 13/28

(52) U.S. Cl. 81/99; 81/111

(57) ABSTRACT

The present invention relates to an open-end wrench, and more particularly to an open-end wrench structural arrangement which represents an improvement in grasping and turning normal or newly-made bolts and nuts of different sizes and/or specifications as well as worn-out bolts and nuts of different sizes and/or specifications.

An open-ended wrench that is used for grasping and turning such fasteners as bolts and nuts of different sizes and/or specifications as well as worn-out bolts and nuts of different sizes and/or specifications.

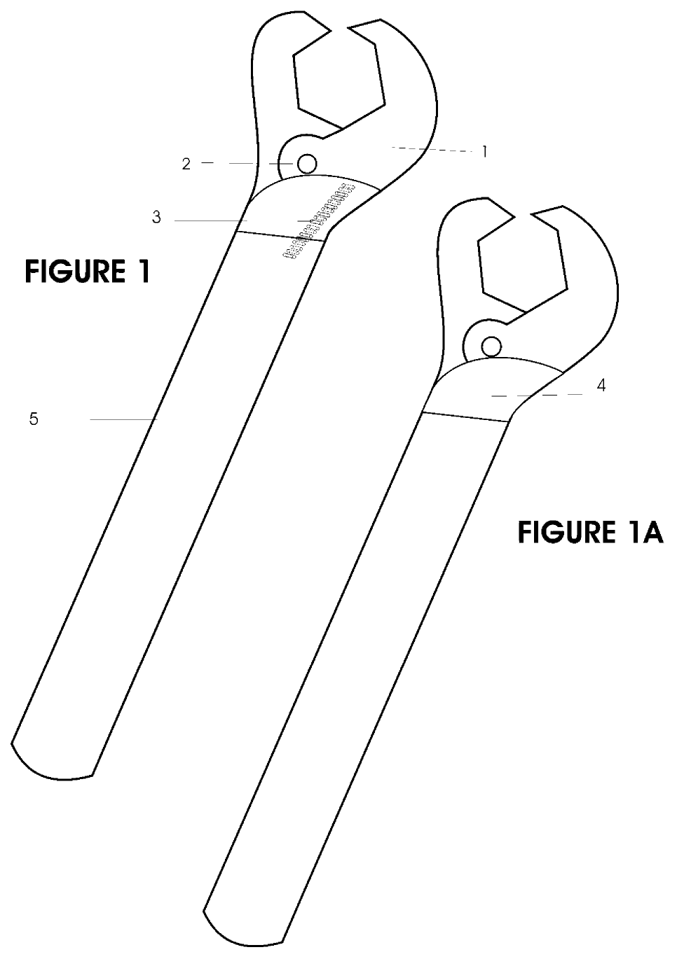

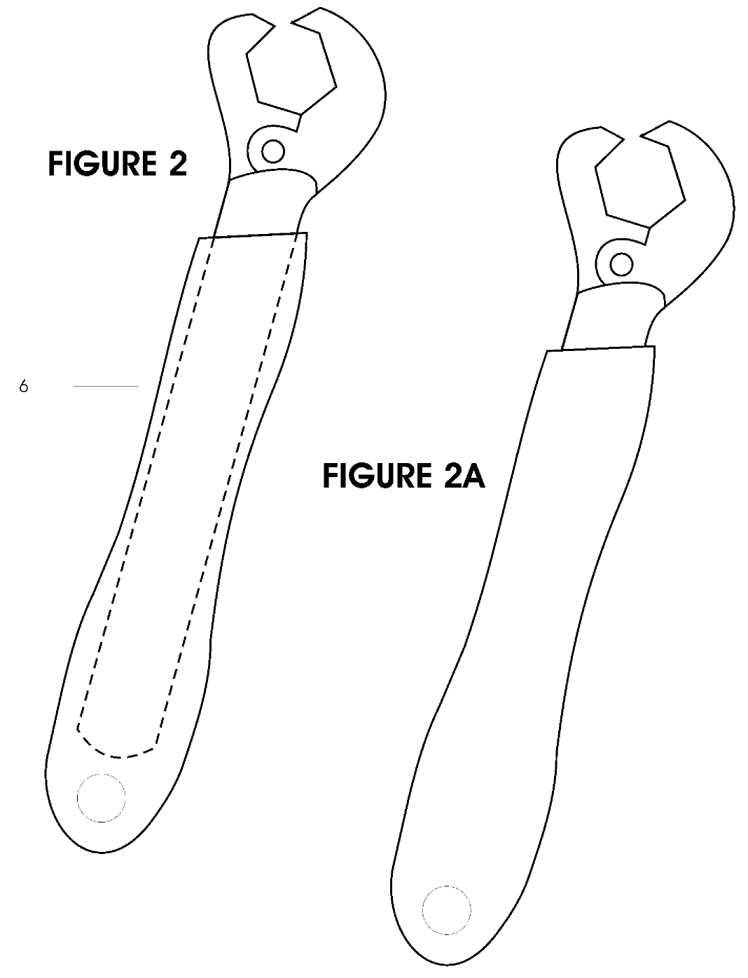

The open-end wrenches shown in FIGS. 1 and 2 are especially designed for grasping and turning hexagon head bolts and nuts of different sizes. The open-end wrench comprises a mouth defined between two jaws and a pin connecting the two jaws. The Open-Ended Wrench is made up of the following parts:

Part 1 Moveable Jaw

Part 2 Steel Pin

Part 3 Spring

Part 4 Protective Cover

Part 5 Arm

Part 6 Rubber handle

FIG. 3 shows the individual pieces of the open-ended wrench. Part #1 is the flexible claw that pivots on the steel pin (Part #2). The steel spring (Part #3) is instered into the arm (Part #5).

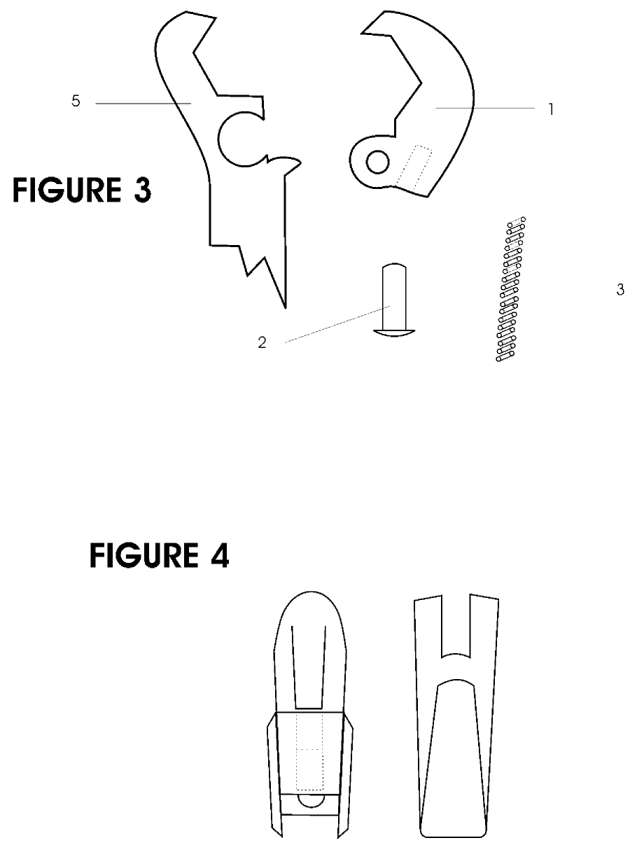

FIG. 4 is a side view drawing of the wrench.

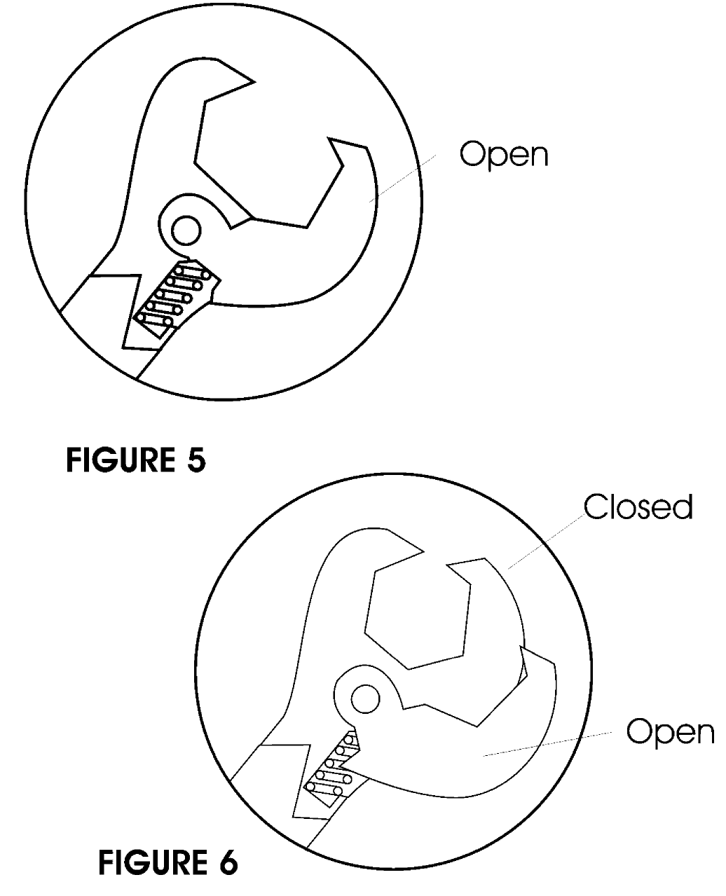

FIGS. 5 and 6 show the wrench in its open and closed position.

What is claimed is:

1. A flexible jaw that adjust to any size bolt or nut automatically.

2. Retractable spring mechanism.

3. Carbon steel structure.
